(19) United States
(12) Patent Application Publication
(10) Pub. No.: US 2026/0213409 A1
(43) Pub. Date: Jul. 23, 2026

(54) RECONFIGURABLE INTELLIGENT SURFACE USING FERROELECTRIC MATERIALS AND METAL-INSULATOR TRANSITION MATERIALS

(71) Applicant: Dell Products L.P., Round Rock, TX (US)

(72) Inventors: Tejinder Singh, Manotick (CA); Navjot Kaur Khaira, Manotick (CA)

(21) Appl. No.: 19/030,600

(22) Filed: Jan. 17, 2025

(51) Int. Cl. H01Q 3/46

(52) U.S. Cl. CPC H01Q 3/46

(57) ABSTRACT

The technology described herein is directed towards a reconfigurable intelligent surface that includes ferroelectric material (e.g., barium strontium titanate) in its unit cells. The ferroelectric material's permittivity varies with applied voltage, whereby individual unit cells are voltage-tunable to set their individual phases via controllably applied voltage. The unit cells can constructively interfere with respect to a redirected instance of an incoming signal, to boost the signal and/or steer the redirected signal as a redirected beam. Further, the use of vanadium dioxide is described, which acts like a conductor when controllably set to its conductive state, or an insulator when set to its nonconductive state. This facilitates selective resonance, such as to determine the effective size (the active aperture) and corresponding gain of a reconfigurable intelligent surface with respect to reflecting an incoming signal. Dual-mode continuous steering is thus made available via the ferroelectric material-plus-vanadium dioxide unit cells.

### BACKGROUND

A reconfigurable intelligent surfaces (RIS), alternatively and interchangeably referred to as a metasurface, is made from an artificially engineered materials designed to have properties not found in naturally occurring materials. They are crafted to manipulate electromagnetic or radio waves in ways that traditional materials cannot, including to redirect an incoming signal in a desired direction. Engineered metasurfaces can be static or reconfigurable when equipped with tunable elements that can adaptively shape and direct EM waves.

### BRIEF DESCRIPTION OF THE DRAWINGS

The technology described herein is illustrated by way of example and not limited in the accompanying figures in which like reference numerals indicate similar elements and in which:

FIGS. 1A and 1B are top and bottom three-dimensional (3D) perspective views, respectively, of an example unit cell that includes ferroelectric material, in accordance with various example embodiments and implementations of the subject disclosure.

FIG. 2A is a cross-sectional view of the example unit cell of FIGS. 1A and 1B, in accordance with various example embodiments and implementations of the subject disclosure.

FIGS. 2B and 2C are top and bottom two-dimensional views, respectively, of a portion of an example reconfigurable intelligent surface (i.e., metasurface) of unit cells, including a zoomed-in view of one of the unit cells, in accordance with various example embodiments and implementations of the subject disclosure.

FIG. 3 is a top 3D perspective view of an example metasurface of unit cells, alongside top and bottom zoomed-in views of one of the unit cells, in accordance with various example embodiments and implementations of the subject disclosure.

FIGS. 4 and 5 are top and bottom two-dimensional views, respectively, of an example metasurface of unit cells, in accordance with various example embodiments and implementations of the subject disclosure.

FIGS. 6 and 7 are graphical representations of simulated performance results (showing reflection magnitude and relative reflection phase, respectively) for an example unit cell, demonstrating the effect of dielectric constant variation of ferroelectric material (barium strontium titanate, or BST), in accordance with various example embodiments and implementations of the subject disclosure.

FIGS. 8 and 9 are graphical representations showing a comparison of the change in example unit cell reflection phase observed for different substrate materials, in accordance with various example embodiments and implementations of the subject disclosure.

FIG. 10 shows some beam scanning angles that can be achieved using a ferroelectric material-based reconfigurable intelligent surface, in accordance with various example embodiments and implementations of the subject disclosure.

FIG. 11 is a flow diagram showing example operations related to applying respective bias voltages, based on phase profile data, to respective ferroelectric layers of respective unit cells of a reconfigurable intelligent surface, to determine the phase profile of the reconfigurable intelligent surface, in accordance with various example embodiments and implementations of the subject disclosure.

### DETAILED DESCRIPTION

The technology described herein is generally directed towards a reconfigurable intelligent surface (RIS, i.e., metasurface) that includes ferroelectric material (e.g., barium strontium titanate (BST)) in the unit cells of a metasurface. For example, thin-film BST provides variable dielectric constants when a DC voltage across the material is changed, which is useable to change the phase of the reflected signal from each unit cell in RIS. Thus, the use of the ferroelectric material results in a tunable unit cell with respect to its phase, with each unit cell being tunable to change the phase profile of the reconfigurable surface. The ferroelectric material allows for a variable phase shift of the reflected signal by adjusting each unit cell's external electric field/electric potential, to achieve beam-scanning with a relatively low hardware cost and relatively ultra-low energy consumption.

The continuous nature of the phase shift that ferroelectric material can provide is in contrast to the limitations of conventional designs that use binary switches or diodes. Indeed, PIN diodes or varactors to achieve phase reconfigurability involves complex signal processing, with high losses and parasitic effects at millimeter wave frequencies. Only limited beam redirection, with relatively slow reconfigurability, can be achieved using PIN diodes and varactors, and the complex wiring/soldering comes with size and integration challenges.

Instead, the ferroelectric material-based metasurface described herein provides a metasurface with a widely reconfigurable phase profile that can be configured and deployed to creates focused beams, and boost signal strength, which among other benefits reduces the chances of signal interception, and can create interferences for an eavesdropper. Such a metasurface can be configured to dynamically react to surroundings, to ensure more optimal performance in a straightforward way to implement a device that can reduce dead spots, cover blind spots, and split signal energy.

It should be understood that any of the examples and/or descriptions herein are non-limiting. Thus, any of the embodiments, example embodiments, concepts, structures, functionalities, or examples described herein are non-limiting, and the technology may be used in various ways that provide benefits and advantages in communications and metasurfaces in general.

Reference throughout this specification to “one embodiment,” “an embodiment,” “one implementation,” “an implementation,” etc. means that a particular feature, structure, characteristic and/or attribute described in connection with the embodiment/implementation can be included in at least one embodiment/implementation. Thus, the appearances of such a phrase “in one embodiment,” “in an implementation,” etc. in various places throughout this specification are not necessarily all referring to the same embodiment/implementation. Furthermore, the particular features, structures, characteristics and/or attributes may be combined in any suitable manner in one or more embodiments/implementations. Repetitive description of like elements employed in respective embodiments may be omitted for sake of brevity.

The detailed description is merely illustrative and is not intended to limit embodiments and/or application or uses of embodiments. Furthermore, there is no intention to be bound by any expressed or implied information presented in the preceding sections, or in the Detailed Description section. Further, it is to be understood that the present disclosure will be described in terms of a given illustrative architecture; however, other architectures, structures, materials and process features, and steps can be varied within the scope of the present disclosure.

It also should be noted that terms used herein, such as “optimize,” “optimization,” “optimal,” “optimally” and the like only represent objectives to move towards a more optimal state, rather than necessarily obtaining ideal results. Similarly, “maximize” means moving towards a maximal state (e.g., up to some processing capacity limit), not necessarily achieving such a state, and so on.

It will also be understood that when an element such as a layer, region or substrate is referred to as being “on” or “over” “atop” “above” “beneath” “below” and so forth with respect to another element, it can be directly on the other element or intervening elements can also be present. In contrast, only if and when an element is referred to as being “directly on” or “directly over” another element, are there no intervening element(s) present. Note that orientation is generally relative; e.g., “on” or “over” can be flipped, and if so, can be considered unchanged, even if technically appearing to be under or below/beneath when represented in a flipped orientation. It will also be understood that when an element is referred to as being “connected” or “coupled” to another element, it can be directly connected or coupled to the other element or intervening elements can be present. In contrast, only if and when an element is referred to as being “directly connected” or “directly coupled” to another element, are there no intervening element(s) present.

One or more example embodiments are now described with reference to the drawings, in which example components, graphs and/or operations are shown, and in which like referenced numerals are used to refer to like elements throughout. In the following description, for purposes of explanation, numerous specific details are set forth in order to provide a more thorough understanding of the one or more embodiments. It is evident, however, in various cases, that the one or more embodiments can be practiced without these specific details, and that the subject disclosure may be embodied in many different forms and should not be construed as limited to the examples set forth herein.

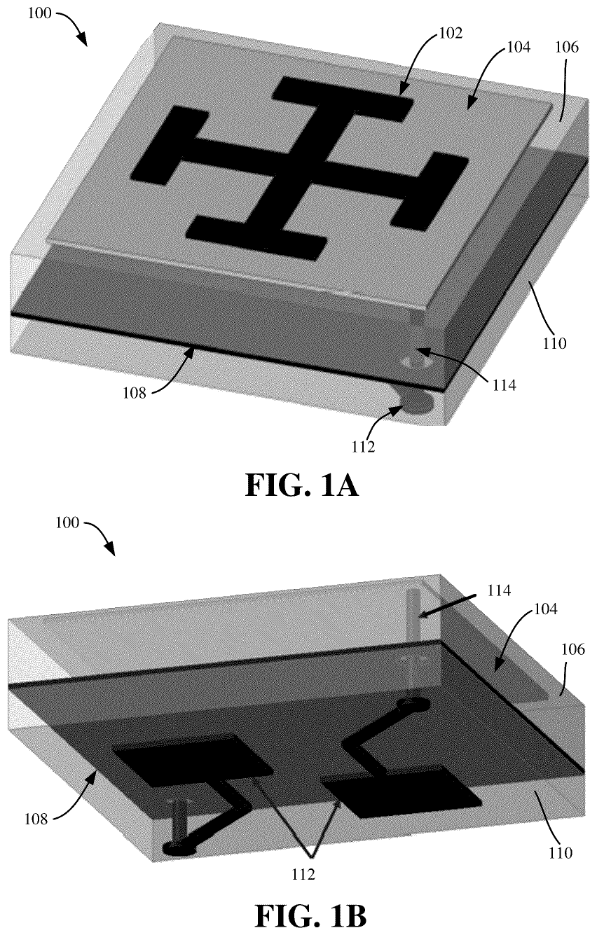

FIGS. 1A and 1B are a three-dimensional (3D) top and bottom perspective views, respectively, of a unit cell device 100. The unit cell device 100 includes a top (upper) metal layer 102 above a ferroelectric layer 104. A top (upper) substrate 106 supports the top metal layer 102 and the ferroelectric layer 104. A ground metallic layer 108 is beneath the top substrate 106 and above a bottom (lower) substrate 110.

Bias contact pads 112 are beneath the bottom (lower) substrate 110 to apply voltage to the ferroelectric layer 104. Vias 114 (one of which is visible in FIGS. 1A and 1B pass the voltage through the substrates 110 and 106, and through the ground metallic layer 108.

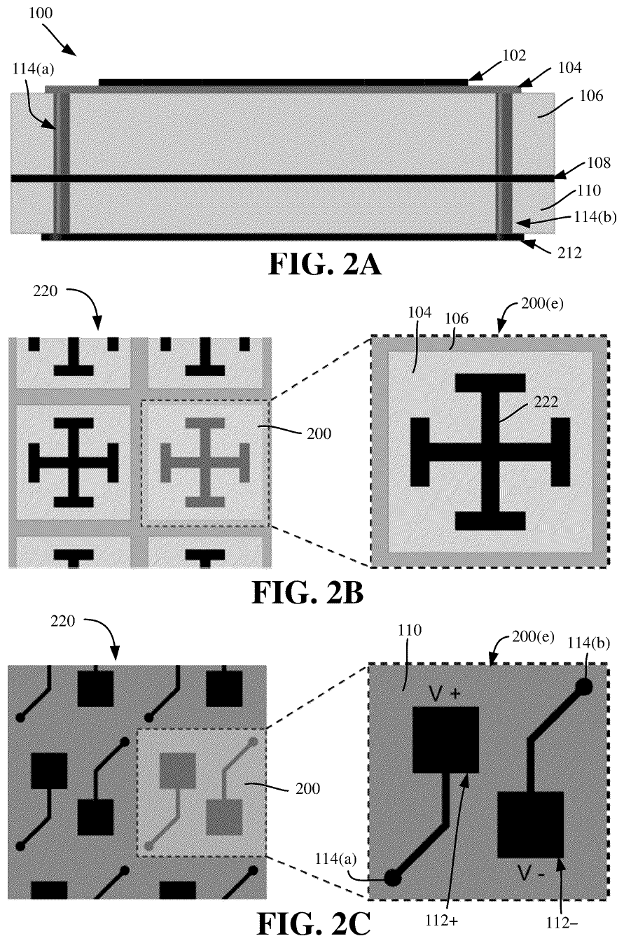

A cross-sectional view of the unit cell 100 is shown in FIG. 2. In this view, both of the vias 114 (labeled 114(a) and 114(b)) are visible. The Bias pads 112 of FIGS. 1A and 1B are shown as a single metal contact pad layer 212 in FIG. 2B, but as in FIG. 1B are electrically separated from one another.

FIGS. 2B and 2C are two-dimensional (2D) top and bottom views, respectively, showing how a unit cell 200 can be combined with other unit cells to form a portion 220 of a reconfigurable intelligent surface. The enlarged view of the unit cell (200(e)) in the top view of FIG. 2B shows the shape of one suitable resonator 222 formed in the top metal layer above the ferroelectric layer 110. The enlarged view of the unit cell (200(e)) in the bottom view of FIG. 2C shows bias pads (112(a) for V+) and (112(b) for V−) and the vias 114(a) and 114(b) for applying a voltage across the ferroelectric layer 110 as described herein.

Note that the top metal resonator shown in the examples herein has a cross-shaped design with generally perpendicular sides and edges that are wider than their stem and crossbar potions. This shape is like the large center cross of a “Jerusalem Cross” shape. While such a shape has been shown as performing well, the technology described herein is not limited to any particular shape of the unit cells'resonator portions.

Ferroelectric materials exhibit spontaneous electric polarization that can be reversed by the application of an external electric field. This behavior is similar to ferromagnetism but with electric dipoles. A suitable ferroelectric materials for the unit cell 100 described herein is barium strontium titanate (BST). The material composition can be represented as a solid solution of barium titanate (BaTiO₃) and strontium titanate (SrTiO₃), denoted as BaₓSr₁₋ₓTiO₃, where ‘x’ controls the proportion of barium and strontium.

BST exhibits a perovskite crystal structure, where the central titanium ion shifts in response to an applied electric field, causing a change in polarization. The material can be polarized in multiple stable states, making it suitable for tunable capacitors and filters. With respect to BST's ferroelectric properties and dielectric tunability, the dielectric constant of BST can be modulated by applying an electric field, making it highly tunable for use in RF and microwave devices like tunable filters and phase shifters.

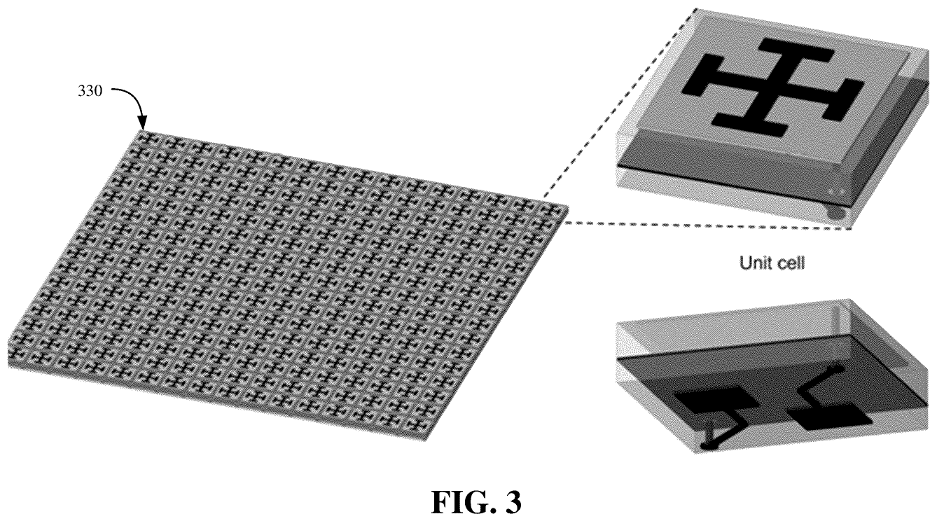

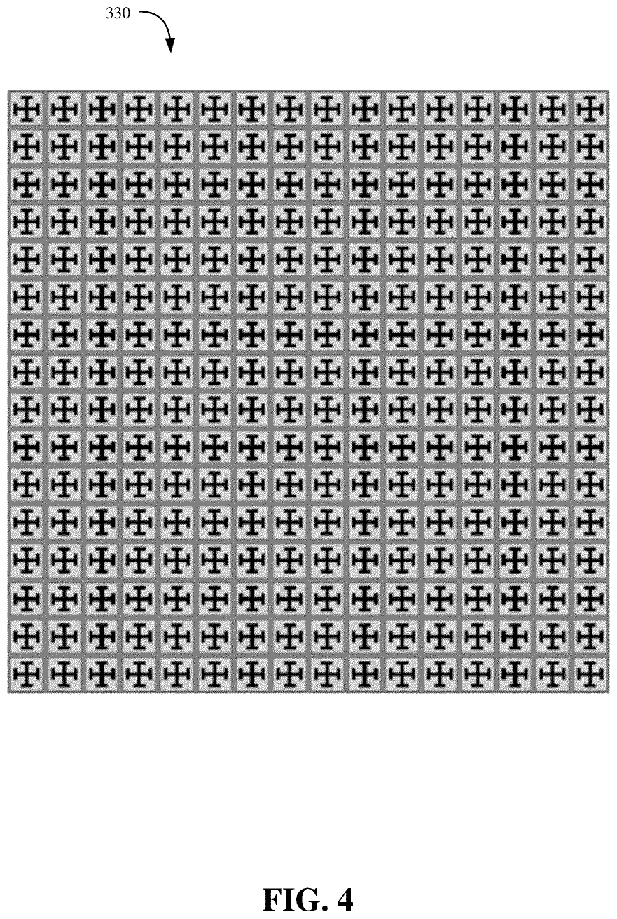

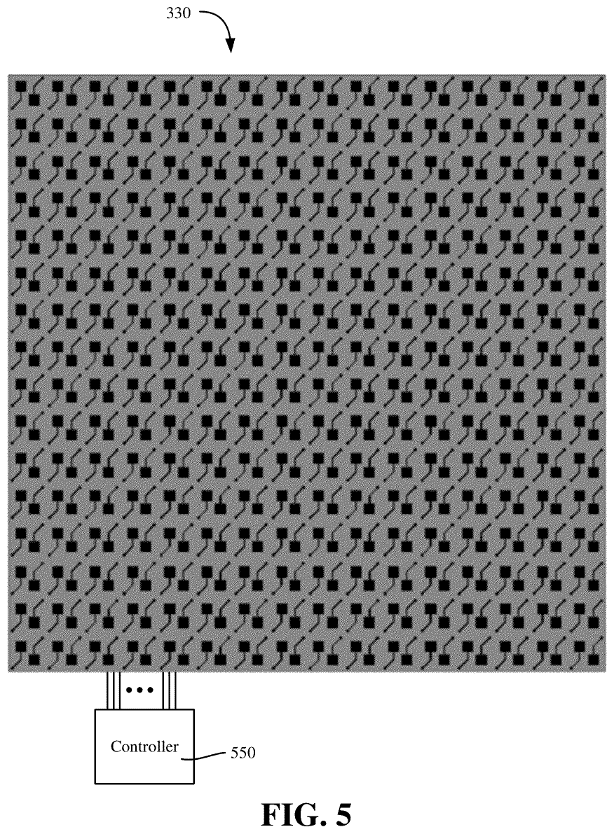

As shown in FIG. 3, one design is a 2D grid-like arrangement of identical unit cells, (also referred to as elements), that together form a metasurface 330, also shown in the top and bottom views of FIGS. 4 and 5, respectively. A 16 ×16 array of unit cells is depicted in FIGS. 3-5, however it should be understood that a metasurface can be designed with any practical number of m×n unit cells. The phase response of each cell is tailored to compensate for different spatial lengths from the feed (the signal source, such as a base station”) in order to achieve constructive interference in a desired direction with respect to reflecting an incoming electromagnetic wave. BST is integrated into each unit cell, and in one example implementation, VO₂ acts as the metallic layer. This integration allows for high operating frequencies due to the absence of interconnects between the tuning element and the reflecting element.

More particularly, described herein is a reconfigurable metasurface (reconfigurable intelligent surface), such as one based on the ferroelectric material barium strontium titanate (BST). By individually applying a variable DC voltage across each BST patch (each ferroelectric layer), e.g., by a controller 550 (FIG. 4), the permittivity of BST is tuned due to its paraelectric behavior, and a variable dielectric constant is realized. The reflection phase from each cell can be continuously controlled, giving a combined effect of beam-steering.

Further, the top metal layer can be vanadium oxide (VO₂), facilitating a dual-mode continuous steering of the reflected beam or transmissive beam. In general, a VO₂ patch can be set to a conductive state or a nonconductive state. In the conductive state, the VO₂ metallic portion is a resonator when an impinging electromagnetic wave of a corresponding frequency is impinging on the unit cell, whereby the wave is reflected based on the phase of the unit cell, (as determined by the permittivity of the ferroelectric material layer as tuned for that unit cell).

When in a nonconductive state, the VO₂ patch does not resonate. As such, a portion of a metasurface can be set as an active aperture with respect to reflecting an incoming signal, while another portion (or portions) of the metasurface are inactive; in other words, for any given unit cell the VO₂ can be controlled (e.g., via heat) to be in its conductive or nonconductive state, with the number of conductive unit cells determining a size of the active aperture. For example, if less array gain is needed, some corresponding number of the outer row(s) and column(s) of unit cells can be set to their nonconductive states, with only a central subarray of the unit cells configured to resonate. If more array gain is needed, more columns and rows are set to their conductive states, increasing the size of the active aperture, up to the full amount of unit cells being set to their conductive states.

Note that only some of the unit cells can be fabricated with a VO₂ patch, that is, some cells can be metal and always resonate, e.g., an inner subarray, with the outer rows/columns able to be controllably set to their conductive or nonconductive states. For fabrication purposes, it may be more straightforward to have all unit cells of a reconfigurable intelligent surface fabricated identically. Further note that it is also feasible to have a metasurface in which at least part of the ground plane is a VO₂ patch that can be controlled to be in a nonconductive state, whereby resonance will not occur at that nonconductive location.

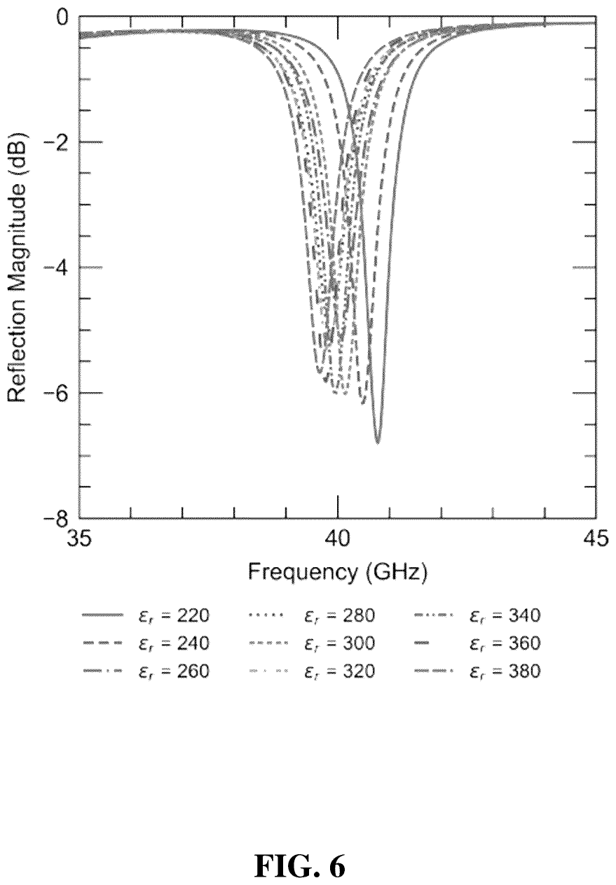

The design and evaluation of both the unit cell and the RIS panel are performed through comprehensive full wave simulations using Ansys HFSS, and the simulation results are presented in FIGS. 6-10 . FIGS. 2B and 2C show a suitable model for the simulations; to summarize, the phase response of the individual cells can be controlled by applying a voltage difference at the bias pads on the bottom, with a uniform thin layer of ferroelectric material (e.g., barium strontium titanate (BST)) monolithically integrated in the fabrication process, with the control mechanism including etched-filled vias and the bias pads at the bottom. The metallic layer can be a VO2 layer.

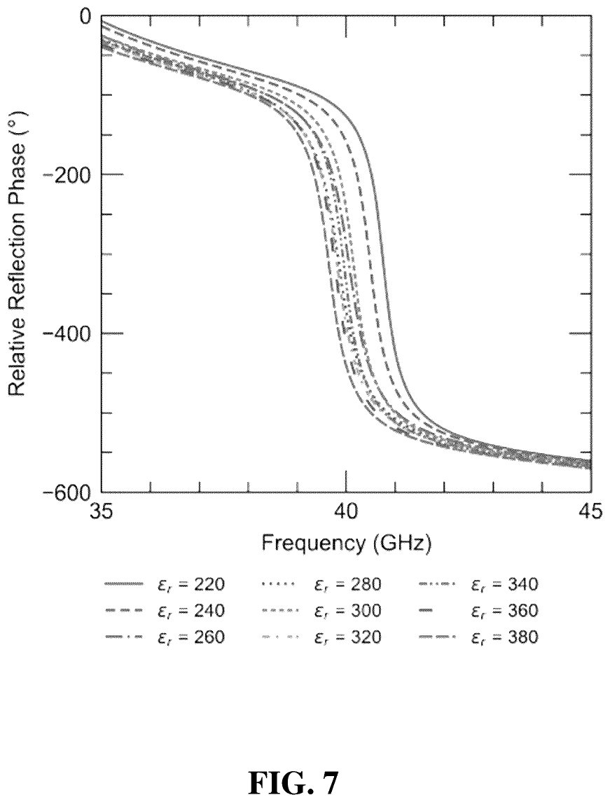

A full-wave EM simulation in Ansys HFSS shows the effect of dielectric constant variation of BST on the unit cell performance at 40 GHz. The analysis is carried out by varying the BST dielectric constant εᵣ from 220 to 380 in steps of 20, assuming the substrate to be silicon and the top metal to be copper (or VO₂ in its conducive state). FIG. 6 shows the reflection magnitude versus frequency for the varied dielectric constants of the BST. FIG. 7 shows the relative reflection phase versus frequency for the varied dielectric constants of the BST.

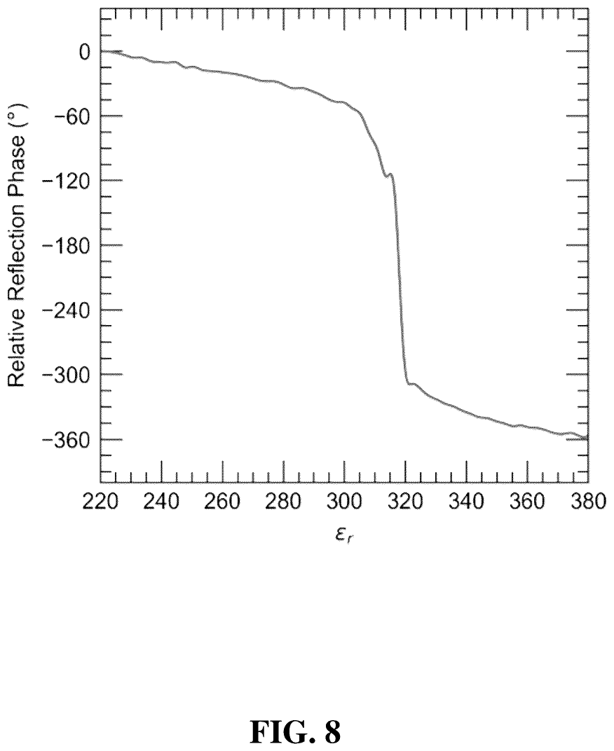

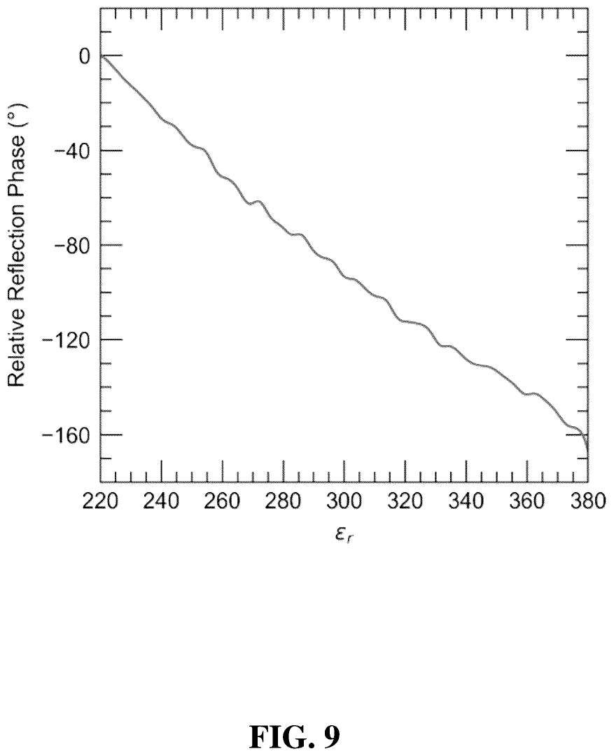

FIGS. 8 and 9 show a comparison of the change in reflection phase observed for substrate material Silicon ((Si) (FIG. 8) versus an FR4 substate (FIG. 9). A tunable phase of 360 degrees is observed for the Si substrate, and a reduced phase tunability of 168 degrees for the FR4 substrate.

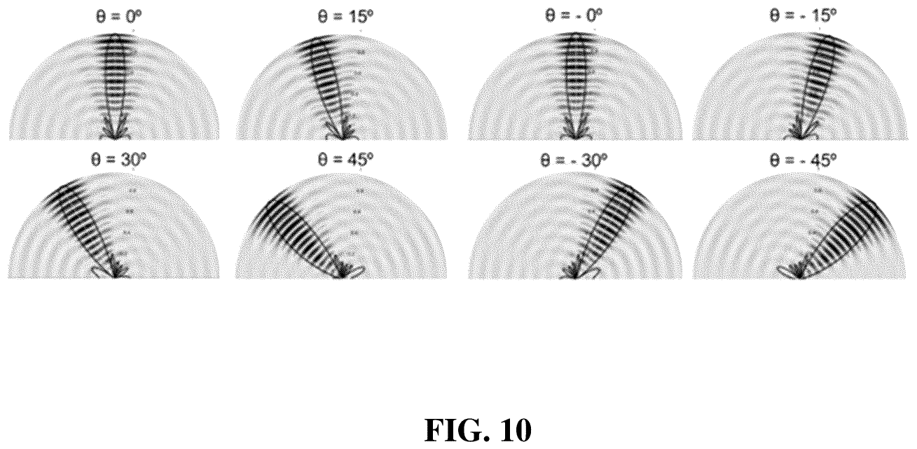

FIG. 10 shows examples of how continuous beam scanning is achieved from a RIS panel using a BST layer as the tuning element. For an incident beam normal to the surface, some of the possible directions of a reflected beam are shown.

One or more example concepts, implementations and/or embodiments can be implemented in a unit cell device, such as described and represented herein. The unit cell device can include a top metal resonator layer, ferroelectric material configured as a ferroelectric layer below the top metal resonator layer, and a ground metallic layer below the ferroelectric material. The unit cell device can include first and second bias pads configured for application of a bias voltage across the first and second bias pads to generate current through the ferroelectric material, in which an amount of the bias voltage determines a dielectric permittivity of the ferroelectric material, and the dielectric permittivity determines a phase response of the unit cell with respect to redirecting an electromagnetic wave impinging on the unit cell device.

The ferroelectric material can include barium strontium titanate.

The ferroelectric material can be above an upper substrate, and the ground metallic layer can be below the upper substrate.

The ground metallic layer can be above a lower substrate, the first and second bias pads can be below the lower substrate; the unit cell device further can include first and second vias insulated from the ground metallic layer, and the first and second vias can electrically couple the first and second bias pads to first and second areas of the ferroelectric material, respectively, through the lower substrate, through the ground metallic layer, and through the upper substrate.

The unit cell device can be part of a reconfigurable intelligent surface of respective unit cell devices comprising the unit cell device.

The top metal resonator layer can include metal-insulator transition material. The metal-insulator transition material can include vanadium dioxide.

The unit cell device further can include a controllable energy transfer element configured to selectively apply energy to the metal-insulator transition material to determine a conductive or nonconductive state of the metal-insulator transition material.

The unit cell device can be part of a reconfigurable intelligent surface of respective unit cell devices comprising the unit cell device, in which the controllable energy transfer element can include a controllable heating element of a heater network, and the heater network can be controlled to determine respective conductive or nonconductive states of at least some of the respective unit cell devices, to determine an active aperture of the reconfigurable intelligent surface with respect to redirecting the electromagnetic wave impinging on the respective unit cells based on respective phase responses of an active unit cell subgroup of the respective unit cells.

The top metal resonator layer can be formed as a cross-shaped portion of metal-insulator transition material. The cross-shaped portion of metal-insulator transition material can include a stem portion and a crossbar portion perpendicular to one another; the stem portion can include first opposite ends that can be perpendicular to the stem portion and wider than a first width of the stem portion between the first opposite ends, and the crossbar portion can include second opposite ends that can be perpendicular to the crossbar portion and wider than a second width of the crossbar portion between the second opposite ends.

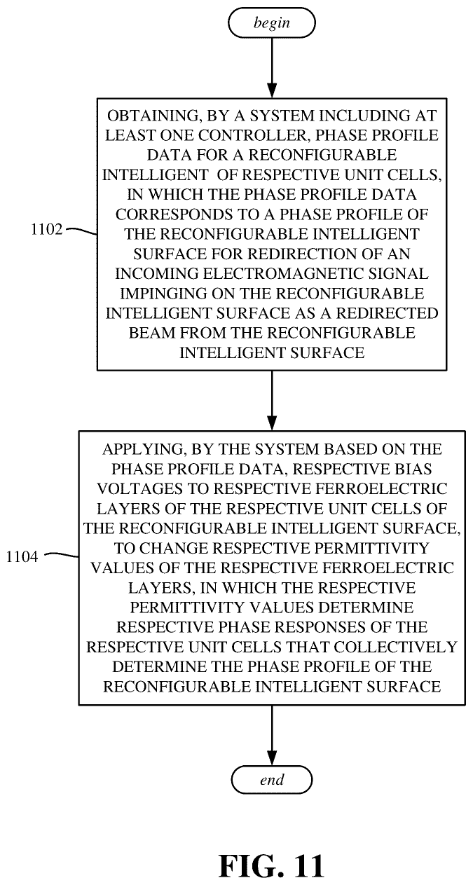

One or more concepts described herein can be implemented in a method, such as represented in the example operations of FIG. 11, (or for example can be implemented in a system that includes at least one memory and/or other machine-readable medium that stores computer executable components and/or operations, and at least one processor that executes computer executable components and/or operations stored in the memory). Example operation 1102 represents obtaining, by a system comprising at least one controller, phase profile data for a reconfigurable intelligent surface of respective unit cells, in which the phase profile data corresponds to a phase profile of the reconfigurable intelligent surface for redirection of an incoming electromagnetic signal impinging on the reconfigurable intelligent surface as a redirected beam from the reconfigurable intelligent surface. Example operation 1104 represents applying, by the system based on the phase profile data, respective bias voltages to respective ferroelectric layers of the respective unit cells of the reconfigurable intelligent surface, to change respective permittivity values of the respective ferroelectric layers, in which the respective permittivity values determine respective phase responses of the respective unit cells that collectively determine the phase profile of the reconfigurable intelligent surface.

The phase profile data can be first phase profile data that corresponds to a first phase profile, the electromagnetic signal can be a first electromagnetic signal, the redirected beam can be a first redirected beam, the respective bias voltages can be first respective bias voltages, the respective permittivity values can be first respective permittivity values, and further operations can include obtaining, by the system, second phase profile data for the reconfigurable intelligent surface that can be different from the first phase profile data, in which the second phase profile data corresponds to a second phase profile of the reconfigurable intelligent surface for redirection of a second incoming electromagnetic signal impinging on the reconfigurable intelligent surface as a second redirected beam from the reconfigurable intelligent surface, and applying, by the system based on the second phase profile data, second respective bias voltages to the respective ferroelectric layers of the respective unit cells of the reconfigurable intelligent surface, to change the first respective permittivity values of the respective ferroelectric layers to second respective permittivity values, in which the second respective permittivity values determine second respective phase responses of the respective unit cells that collectively determine the second phase profile of the reconfigurable intelligent surface.

A group of the respective unit cells can include respective phase change material layers, and further operations can include obtaining, by the system, aperture data representative of an active aperture portion of the reconfigurable intelligent surface with respect to redirecting the incoming electromagnetic signal, and applying, by the system based on the aperture data, heat to a subgroup of the group of respective phase change material layers, to configure the active aperture portion by determining respective conductive states or nonconductive states of the group of the respective unit cells.

The subgroup can be a first subgroup, the aperture data can be first aperture data, the active aperture portion can be a first active aperture portion, the incoming electromagnetic signal can be a first incoming electromagnetic signal redirected based on the first aperture portion, the heat can be first heat, the respective conductive states or nonconductive states can be first respective conductive states or nonconductive states, and further operations can include obtaining, by the system, second aperture data representative of a second active aperture portion of the reconfigurable intelligent surface with respect to redirecting a second incoming electromagnetic signal, and applying, by the system based on the second aperture data, second heat to a second subgroup of the group of respective phase change material layers to configure the second active aperture portion by determining second respective conductive states or nonconductive states of the group of the respective unit cells.

One or more example concepts, implementations and/or embodiments can be implemented in a system, such as described and represented herein. The system can include a reconfigurable intelligent surface of respective unit cells, and the respective unit cells co can include respective resonating layers above respective ferroelectric layers. The system can include at least one controller configured to: obtain respective voltage biases corresponding to a phase profile of the reconfigurable intelligent surface, and apply the respective voltage biases to the respective ferroelectric layers to determine respective permittivity values of the respective ferroelectric layers. The respective permittivity values determine respective phase responses of the respective unit cells to redirect an incoming electromagnetic signal impinging on the reconfigurable intelligent surface as a redirected beam based on the phase profile.

The phase profile can be a first phase profile, the respective voltage biases can be first respective voltage biases, the respective permittivity values can be first respective permittivity values, the respective phase responses can be first respective phase responses, the incoming electromagnetic signal can be a first incoming electromagnetic signal, the redirected beam can be a first redirected beam, and the at least one controller can be further configured to obtain second respective voltage biases corresponding to a second phase profile of the reconfigurable intelligent surface; the second phase profile can be different from the first phase profile. The at least one controller can be further configured to apply the second respective voltage biases to the respective ferroelectric layers to determine second respective permittivity values of the respective ferroelectric layers; the second respective permittivity values determine second respective phase responses of the respective unit cells to redirect a second incoming electromagnetic signal impinging on the reconfigurable intelligent surface as a second redirected beam based on the second phase profile.

The respective resonating layers can include a group of respective phase change material layers, and the at least one controller can be further configured to apply heat to a subgroup of the group of respective phase change material layers to determine respective conductive states or nonconductive states of the group of the respective unit cells and determine an active aperture area of the reconfigurable intelligent surface that redirects the incoming electromagnetic signal as the redirected beam.

The heat can be first heat, the subgroup can be a first subgroup, the respective conductive states or nonconductive states can be first respective conductive states or nonconductive states, the incoming electromagnetic signal can be a first incoming electromagnetic signal, the active aperture area can be a first active aperture area, and the at least one controller can be further configured to apply second heat to a second subgroup of the group of respective phase change material layers to determine second respective conductive states or nonconductive states of the group of the respective unit cells and determine a second active aperture area of the reconfigurable intelligent surface that redirects a second incoming electromagnetic signal as a second redirected beam based at least in part on the active aperture area.

The phase profile can be a first phase profile, the respective voltage biases can be first respective voltage biases, the respective permittivity values can be first respective permittivity values, the respective phase responses can be first respective phase responses, and the at least one controller can be further configured to obtain second respective voltage biases corresponding to a second phase profile of the reconfigurable intelligent surface; the second phase profile can be different from the first phase profile; and apply the second respective voltage biases to the respective ferroelectric layers to determine second respective permittivity values of the respective ferroelectric layers, in which the second respective permittivity values determine second respective phase responses of the respective unit cells to redirect the second incoming electromagnetic signal impinging on the reconfigurable intelligent surface as the second redirected beam based at least in part on the second phase profile.

As can be seen, described is using ferroelectric material (e.g., BST) for tuning a unit cell's phase response based on controllably varying the dielectric constant of the ferroelectric material. Further, example implementations of the technology described herein are directed to a dual-mode, BST and VO2-integrated, continuously tunable metasurface capable of operating at relatively high frequency bands (e.g., 40 GHz). With the application of DC voltages to individual unit cells, the dielectric constant of the BST layer in a unit cell is changed, e.g., to facilitate beam steering from a metasurface of unit cells. In addition, the VO2 can be configured to conductive or dielectric mode, which facilitates continuous tuning in reflection or transmission space, as well as selection of array gain via controlling the size of an active reflecting aperture of a metasurface.

A monolithic integration approach can be used to fabricate a metasurface. Fabrication can use a clean integration of the BST layer in the fabrication process, hence eliminating the need for any soldering or wire bonding interconnections. Further, unlike conventional reconfigurable metasurfaces that often require significant power for tuning, the ferroelectric metasurface offers low-power operation by leveraging the inherent properties of ferroelectric materials. This makes it highly energy-efficient and suitable for power-sensitive applications.

The above description of illustrated embodiments of the subject disclosure, comprising what is described in the Abstract, is not intended to be exhaustive or to limit the disclosed embodiments to the precise forms disclosed. While specific embodiments and examples are described herein for illustrative purposes, various modifications are possible that are considered within the scope of such embodiments and examples, as those skilled in the relevant art can recognize.

In this regard, while the disclosed subject matter has been described in connection with various embodiments and corresponding Figures, where applicable, it is to be understood that other similar embodiments can be used or modifications and additions can be made to the described embodiments for performing the same, similar, alternative, or substitute function of the disclosed subject matter without deviating therefrom. Therefore, the disclosed subject matter should not be limited to any single embodiment described herein, but rather should be construed in breadth and scope in accordance with the appended claims below.

As used in this application, the terms “component,” “system,” “platform,” “layer,” “selector,” “interface,” and the like are intended to refer to a computer-related resource or an entity related to an operational apparatus with one or more specific functionalities, wherein the entity can be either hardware, a combination of hardware and software, software, or software in execution. As an example, a component can be an apparatus with specific functionality provided by mechanical parts operated by electric or electronic circuitry. As yet another example, a component can be an apparatus that provides specific functionality through electronic components without mechanical parts, the electronic components can comprise a processor therein to execute software or firmware that confers at least in part the functionality of the electronic components.

In addition, the term “or” is intended to mean an inclusive “or” rather than an exclusive “or.” That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances.

While the embodiments are susceptible to various modifications and alternative constructions, certain illustrated implementations thereof are shown in the drawings and have been described above in detail. It should be understood, however, that there is no intention to limit the various embodiments to the specific forms disclosed, but on the contrary, the intention is to cover all modifications, alternative constructions, and equivalents falling within the spirit and scope.

In addition to the various implementations described herein, it is to be understood that other similar implementations can be used or modifications and additions can be made to the described implementation(s) for performing the same or equivalent function of the corresponding implementation(s) without deviating therefrom. Still further, multiple processing chips or multiple devices can share the performance of one or more functions described herein, and similarly, storage can be effected across a plurality of devices. Accordingly, the various embodiments are not to be limited to any single implementation, but rather are to be construed in breadth, spirit and scope in accordance with the appended claims.

What is claimed is:

1. A unit cell device, comprising:
a top metal resonator layer;
ferroelectric material configured as a ferroelectric layer below the top metal resonator layer;
a ground metallic layer below the ferroelectric material; and
first and second bias pads configured for application of a bias voltage across the first and second bias pads to generate current through the ferroelectric material, wherein an amount of the bias voltage determines a dielectric permittivity of the ferroelectric material, and the dielectric permittivity determines a phase response of the unit cell with respect to redirecting an electromagnetic wave impinging on the unit cell device.

2. The unit cell device of claim 1, wherein the ferroelectric material comprises barium strontium titanate.

3. The unit cell device of claim 1, wherein the ferroelectric material is above an upper substrate, and wherein the ground metallic layer is below the upper substrate.

4. The unit cell device of claim 3, wherein the ground metallic layer is above a lower substrate, wherein the first and second bias pads are below the lower substrate, and further comprising first and second vias insulated from the ground metallic layer, and wherein the first and second vias electrically couple the first and second bias pads to first and second areas of the ferroelectric material, respectively, through the lower substrate, through the ground metallic layer, and through the upper substrate.

5. The unit cell device of claim 1, wherein the unit cell device is part of a reconfigurable intelligent surface of respective unit cell devices comprising the unit cell device.

6. The unit cell device of claim 1, wherein the top metal resonator layer comprises metal-insulator transition material.

7. The unit cell device of claim 6, wherein the metal-insulator transition material comprises vanadium dioxide.

8. The unit cell device of claim 6, further comprising a controllable energy transfer element configured to selectively apply energy to the metal-insulator transition material to determine a conductive or nonconductive state of the metal-insulator transition material.

9. The unit cell device of claim 6, wherein the unit cell device is part of a reconfigurable intelligent surface of respective unit cell devices comprising the unit cell device, wherein the controllable energy transfer element comprises a controllable heating element of a heater network, and wherein the heater network is controlled to determine respective conductive or nonconductive states of at least some of the respective unit cell devices, to determine an active aperture of the reconfigurable intelligent surface with respect to redirecting the electromagnetic wave impinging on the respective unit cells based on respective phase responses of an active unit cell subgroup of the respective unit cells.

10. The unit cell device of claim 1, wherein the top metal resonator layer is formed as a cross-shaped portion of metal-insulator transition material.

11. The unit cell device of claim 10, wherein the cross-shaped portion of metal-insulator transition material comprises a stem portion and a crossbar portion perpendicular to one another, wherein the stem portion comprises first opposite ends that are perpendicular to the stem portion and wider than a first width of the stem portion between the first opposite ends, and wherein the crossbar portion comprises second opposite ends that are perpendicular to the crossbar portion and wider than a second width of the crossbar portion between the second opposite ends.

12. A method, comprising:
obtaining, by a system comprising at least one controller, phase profile data for a reconfigurable intelligent surface of respective unit cells, wherein the phase profile data corresponds to a phase profile of the reconfigurable intelligent surface for redirection of an incoming electromagnetic signal impinging on the reconfigurable intelligent surface as a redirected beam from the reconfigurable intelligent surface; and
applying, by the system based on the phase profile data, respective bias voltages to respective ferroelectric layers of the respective unit cells of the reconfigurable intelligent surface, to change respective permittivity values of the respective ferroelectric layers, wherein the respective permittivity values determine respective phase responses of the respective unit cells that collectively determine the phase profile of the reconfigurable intelligent surface.

13. The method of claim 12, wherein the phase profile data is first phase profile data that corresponds to a first phase profile, wherein the electromagnetic signal is a first electromagnetic signal, wherein the redirected beam is a first redirected beam, wherein the respective bias voltages are first respective bias voltages, wherein the respective permittivity values are first respective permittivity values, and further comprising:
obtaining, by the system, second phase profile data for the reconfigurable intelligent surface that is different from the first phase profile data, wherein the second phase profile data corresponds to a second phase profile of the reconfigurable intelligent surface for redirection of a second incoming electromagnetic signal impinging on the reconfigurable intelligent surface as a second redirected beam from the reconfigurable intelligent surface; and
applying, by the system based on the second phase profile data, second respective bias voltages to the respective ferroelectric layers of the respective unit cells of the reconfigurable intelligent surface, to change the first respective permittivity values of the respective ferroelectric layers to second respective permittivity values, wherein the second respective permittivity values determine second respective phase responses of the respective unit cells that collectively determine the second phase profile of the reconfigurable intelligent surface.

14. The method of claim 12, wherein a group of the respective unit cells comprise respective phase change material layers, and further comprising obtaining, by the system, aperture data representative of an active aperture portion of the reconfigurable intelligent surface with respect to redirecting the incoming electromagnetic signal, and applying, by the system based on the aperture data, heat to a subgroup of the group of respective phase change material layers, to configure the active aperture portion by determining respective conductive states or nonconductive states of the group of the respective unit cells.

15. The method of claim 14, wherein the subgroup is a first subgroup, wherein the aperture data is first aperture data, wherein the active aperture portion is a first active aperture portion, wherein the incoming electromagnetic signal is a first incoming electromagnetic signal redirected based on the first aperture portion, wherein the heat is first heat, wherein the respective conductive states or nonconductive states are first respective conductive states or nonconductive states, and further comprising:
obtaining, by the system, second aperture data representative of a second active aperture portion of the reconfigurable intelligent surface with respect to redirecting a second incoming electromagnetic signal, and
applying, by the system based on the second aperture data, second heat to a second subgroup of the group of respective phase change material layers to configure the second active aperture portion by determining second respective conductive states or nonconductive states of the group of the respective unit cells.

16. A system, comprising:
a reconfigurable intelligent surface of respective unit cells, the respective unit cells comprising respective resonating layers above respective ferroelectric layers; and
at least one controller configured to:
obtain respective voltage biases corresponding to a phase profile of the reconfigurable intelligent surface; and
apply the respective voltage biases to the respective ferroelectric layers to determine respective permittivity values of the respective ferroelectric layers,
wherein the respective permittivity values determine respective phase responses of the respective unit cells to redirect an incoming electromagnetic signal impinging on the reconfigurable intelligent surface as a redirected beam based on the phase profile.

17. The system of claim 16, wherein the phase profile is a first phase profile, wherein the respective voltage biases are first respective voltage biases, wherein the respective permittivity values are first respective permittivity values, wherein the respective phase responses are first respective phase responses, wherein the incoming electromagnetic signal is a first incoming electromagnetic signal, wherein the redirected beam is a first redirected beam, and wherein the at least one controller is further configured to:
obtain second respective voltage biases corresponding to a second phase profile of the reconfigurable intelligent surface, wherein the second phase profile is different from the first phase profile; and
apply the second respective voltage biases to the respective ferroelectric layers to determine second respective permittivity values of the respective ferroelectric layers,
wherein the second respective permittivity values determine second respective phase responses of the respective unit cells to redirect a second incoming electromagnetic signal impinging on the reconfigurable intelligent surface as a second redirected beam based on the second phase profile.

18. The system of claim 16, wherein the respective resonating layers comprise a group of respective phase change material layers, and wherein the at least one controller is further configured to apply heat to a subgroup of the group of respective phase change material layers to determine respective conductive states or nonconductive states of the group of the respective unit cells and determine an active aperture area of the reconfigurable intelligent surface that redirects the incoming electromagnetic signal as the redirected beam.

19. The system of claim 18, wherein the heat is first heat, wherein the subgroup is a first subgroup, wherein the respective conductive states or nonconductive states are first respective conductive states or nonconductive states, wherein the incoming electromagnetic signal is a first incoming electromagnetic signal, wherein the active aperture area is a first active aperture area, and wherein the at least one controller is further configured to apply second heat to a second subgroup of the group of respective phase change material layers to determine second respective conductive states or nonconductive states of the group of the respective unit cells and determine a second active aperture area of the reconfigurable intelligent surface that redirects a second incoming electromagnetic signal as a second redirected beam based at least in part on the active aperture area.

20. The system of claim 19, wherein the phase profile is a first phase profile, wherein the respective voltage biases are first respective voltage biases, wherein the respective permittivity values are first respective permittivity values, wherein the respective phase responses are first respective phase responses, and wherein the at least one controller is further configured to:
obtain second respective voltage biases corresponding to a second phase profile of the reconfigurable intelligent surface, wherein the second phase profile is different from the first phase profile; and
apply the second respective voltage biases to the respective ferroelectric layers to determine second respective permittivity values of the respective ferroelectric layers,
wherein the second respective permittivity values determine second respective phase responses of the respective unit cells to redirect the second incoming electromagnetic signal impinging on the reconfigurable intelligent surface as the second redirected beam based at least in part on the second phase profile.
